(19) United States
(12) Patent Application Publication
(10) Pub. No.: US 2017/0155636 A1
(43) Pub. Date: Jun. 1, 2017

(54) DIGITAL BOOK SYSTEM

(71) Applicant: TECHSTORM TECHNOLOGY PTE LTD, Singapore (SG)

(72) Inventors: IWAN IMAN, Kembangan Utara (ID); DJOKO HERMAN PRAJITNO, Kamal Muara Penjaringan (ID)

(21) Appl. No.: 15/313,560

(22) PCT Filed: Apr. 23, 2015
(86) PCT No.: PCT/SG2015/000122

§ 371 Date: Nov. 23, 2016

(30) Foreign Application Priority Data
May 26, 2014 (ID) P000201403078

(51) Int. Cl. H04L 29/06; G06Q 30/06

(52) U.S. Cl. CPC H04L 63/083; G06Q 30/0609; G06Q 30/0635

(57) ABSTRACT

A system and method of obtaining a digital book which has the following features is provided: the book scanned by a camera will have the same appearance as the physical book (cover, content), the content of the book will be encrypted by the system, that it will be safe of data leak, moreover if the user device is lost, because the file in the book is encrypted, the person trying to retrieve the file in the user device will not be able to read the data, the file can only be read by application suitable for only this invention, during the scanning, the system will automatically read the codes that the book will be arranged automatically based on its physical arrangement.

### CROSS-REFERENCE TO RELATED APPLICATIONS

This application claims priority to PCT Application No. PCT/SG2015/000122, having a filing date of Apr. 23, 2015, based off of ID Application No. P000201403078 having a filing date of May 26, 2014, the entire contents of which are hereby incorporated by reference.

### FIELD OF TECHNOLOGY

The following relates with digital book, especially with digital book services which are accessible on handheld devices, such as cellular telephone, tablet computer or laptop.

### BACKGROUND

Digital book can also be labeled as e-book or electronic book. Digital book is a form of book which we can open through electronic media, such as through computer (PC/Laptop), PC tablet and smart phones. Digital book has various file formats, such as PDF (Portable Document Format), Microsoft Office (by protect system), .htm format to .exe format.

In this technology era, digital book (e-book) is the solution for writers in publishing their works, in addition to save fund in printing the book manually, e-book is also the solution in minimizing the impact of global warming. Let's calculate the condition if we print only one book, say 1,000 exemplars with 80 sheets each: 80 sheets×1,000 exemplars—80,000 sheets of paper. How many writers in this world who have published their books manually? How many billion papers we have used, how many thousand liters of ink we used, and how many billion power of electricity we have spent? Also think about the pollution the paper and ink factories have caused? Actually it's only the content which will define where we will get the benefit, message and insights in the book. Most Indonesian people now have computers, tablets and smart phones, so it would be practical to read books via smart phones or tablets instead of carrying a big bag full of books.

Notebook or drawing book users very fond of collecting and keeping their books. Even after the books are all written up, they still keep them. It happens because they will need the books in the future, for example, a fourth grader will need his or her books for the national examination a couple of years later. But when the books are kept, in the long run it will be greater in amount and will need large storage. Moreover, books are easily damaged if they are kept in damp room; they will be moldy and devoured by tiny bugs. Making the books digital is the way out.

### SUMMARY

An aspect relates to a notebook with similar functions as regular books, but it has special codes which later will be translated by a system suitable for embodiments of the invention (called the Ascentpeak system) in order to be digital.

The purpose of embodiments of the invention is to serve a digital book which content will be encrypted by the system, that it will be prevented from data leaking.

Other purposes of embodiments of the invention is to serve a digital book system installable on handheld devices (smart phones, tablet computers, etc.) that if the device is lost, because the file in the book is encrypted, the person trying to retrieve the file in the user device will not be able to read the data.

The specialty of embodiments of the invention is as follows: the book scanned by camera will have similar appearance as its physical book (cover, content); the content will be encrypted by the system, that it will be safe of data leak, and if the user device is lost, because the file in the book is encrypted, the person trying to retrieve the file in the user device will not be able to read the data: the file can only be read by application in accordance with embodiments of the invention; during the scanning, the system will automatically read the codes that the book will be arranged automatically based on its physical arrangement, without the user needs to intervene; if the first page is scanned, the book will digitally show the first page, and the next page, although it is scanned the last; the book will be able to be used together by fellow users (shared-usage facility), able for tagging/grouping with special stickers which will later be detected by the system; for premium version, the book is digitally editable.

### BRIEF DESCRIPTION

Some of the embodiments will be described in detail, with reference to the following figures, wherein like designations denote like members, wherein:

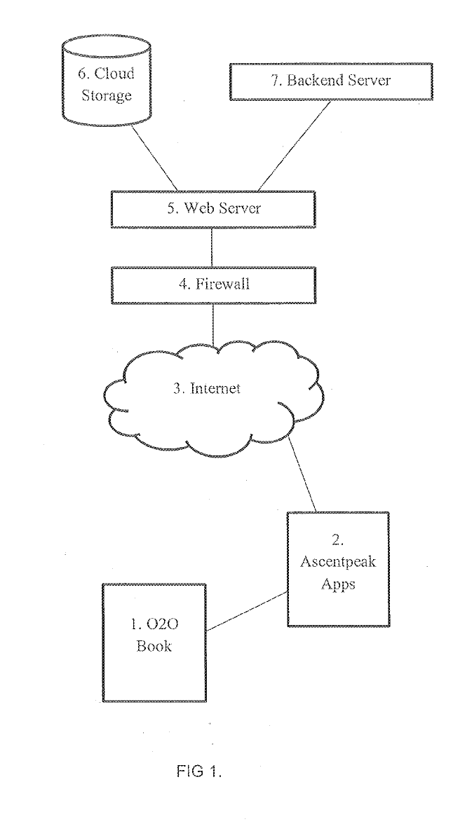

FIG. 1 illustrates digital book system in accordance with embodiments of the invention; and

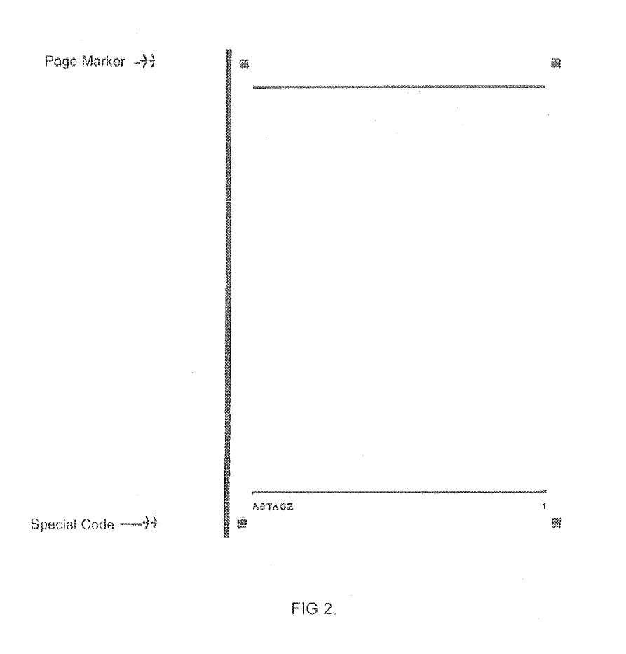

FIG. 2 is the parts of the digital book in accordance with embodiments of the invention.

### DETAILED DESCRIPTION

FIG. 1 illustrates digital book system of this invention, where the usage method of this invention is as follows; to be able to use the application suitable for this invention (which is called the ascent peak), user must buy a book from this invention (in offline to online). The book is equipped with book codes to be inserted to the invention's application.

Then user must register their username and password first before they can use this invention application (called the ascent peak) in this application registration web (http://www.ascentpeak.com/register). Having registered in this application web, user will get username and password to login to this invention application.

Furthermore, user downloads this application in Google Play or Apple Store. After downloading it, user opens the application suitable for this invention in their handheld device; after they login to this application to server, by getting to the setting menu. Enter login and password and then return to the main menu by choosing home. To enter a new book, choose ‘plus’ button in the main page and enter the book code bought, and the book title. The title is used to ease user remembering the book. By the time the code is inserted and returned to the main menu, the cover of the book bought will be visible in the bookshelf display. To enter and read the book content, choose the image of the book so the content will be displayed. If the content has never been inserted before, choose ‘add page’ so user will get to book scan menu, and scan the related book. Choose OK when the display is correct and the content will be inserted and readable in the application suitable for embodiments of the invention (called the ascent peak).

Meanwhile FIG. 2 illustrates the parts of the digital book suitable for embodiments of the invention, which consists of:

1. Book Code. Book code functions as authentication and also special identification which signifies the book. The book code is unique and is owned by only one book. Therefore there will not be the same code for a number of books in the system. The book code is unique and is owned by only one book. With this code we can map the title of the book to be used. The code consists of a minimum of 5×3 codes in the form of alphanumeric and sensitive case. The first 5 digits of the code also determine the cover of the book. For example: abcdf-234jh-34iuG, which consists of:
special code
The special code consists of 6 digits of letter which always starts with the letter A in the first digit and letter Z in the last digit. The rest 4 letters/digits signify the code correlating with the system arranging page automation during scanning page. The code is a letter code and using capital letters. For example: ASTACZ
page code
The code is page component on books, and as page signifier just like in ordinary books. In the system, the part is the comparison for the special code. The code is in the form of numbers showing the book's page. For example: 11.
page marker
Page marker is a code in squared form, which functions as identifier of the book that the book is recognized by the system.

2. Application. The application suitable for embodiments of the invention is mobile application made on two platforms, namely Android and iOS (Apple). The application functions as:
bookshelf
This is the main display, which is also seen as list of books owned therefore they are arranged neatly.
scanner
With this application, the book can only be read by using this application for security.

3. Internet. In this system, internet is used both in the mobile device or on this invention server, because it needs online connection so the data can be retrieved from server.

4. Firewall. Firewall is used as server security that it is safe from disturbances such as virus or data leak.

5. Web Server. Web server in this system has a number of functions:
Authentication
During the first time the application suitable for embodiments of the invention is run, the application will try to connect the server. Therefore there will be vibration between this application (called the ascentpeak application) and the web server, whether the application has been registered by its user or not. If it is not, the application will force its user to register at the registration web. If the user is registered, the application will try to synchronize the book data and the user book coder by the backend server, download the undownloaded book therefore the book can be read online and offline.
Registration
This registration functions to create user and password that user can use the ascentpeak application. In registration, user will be asked to fill in some data such as name, e-mail address, username wanted and also the password. This registration web can be made in accordance with marketing needs.
Online Book Reader
In addition to be readable in mobile device, this online book can also be read by using computer (notebook/desktop) by their web. Moreover, this web is used to set additional features such as book share.

Most of this web application is developed by using php programming language, because it has a more open system.

6. Cloud storage. This cloud storage is used to store book data of each user, therefore user will not lose their data although they change their device, because all the books are stored in the cloud storage until a certain limit of time (in accordance with the terms and conditions of the related book). For premium book user, the time limit of storage can be extended in accordance with request/rent.

7. Backend server. This backend server is the brain of all system automation processes:
Image Code Scanning
This is the most important part of the ascentpeak system. The image sent to the server by ascent peak application will be translated by processing the image created and comparing it with the existing characters/codes to obtain written characters/codes. The principle is also applicable for grouping/tagging process to obtain the nearest result.
Page Automation
When user scans the book suitable for embodiments of the invention (called the 020 book), after the code is obtained backend server will order for book setting automatically based on the related pages, copy it to cloud storage and also order the ascentpeak application to retrieve the page from the cloud storage.
Database
This part will set all book databases, from book code, book setting, page, user data, book grouping and many more. The database used is MYSQ1 but it can be replaced with SQL suitable for the database, in accordance with the number of user accessing the data.
Setting

This part also performs setting where the file and book content will be stored in its cloud storage part

Meanwhile the embodiments of the examples are especially described by referring to the images. It is comprehended by experts in this field that various changes in the form and details to be created in it without deviating from the core and scope of the inventive concept as is stipulated by the claims attached. The example embodiments are supposed to be considered in the description only and not for limitation purposes. Therefore, the scope of this invention is stipulated not with detailed explanation of the example embodiments, but by claims attached, and all the differences in the scope will be explained as it is covered in this invention.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A digital book system comprising:
a book including:
a book code which functions as an authentication and also as a special identification that signifies the book,
a special code having six digits of a letter which always starts with letter A on a first digit and letter Z on a last digit, and the remainder 4 letters/digits signify a code correlating with a system setting a page automation during page scanning,
a page code which is a page component on the book and as a page marker,
a page marker, the page marker being a square-shaped code which functions as the identifier of the book, and
a scanner to copy digitally;
a book reader to read the book after it is scanned by scanner;
a web server which has the following functions:
authentication to authenticate during the first time the application is run,
registration which functions to create a username and a password for the user; and
online book reader to read the book via internet;
a cloud storage which is used to store book data of each user, so that the user does not lose the user's data, even if the user changes the user's device until a certain period of time;
a backend server that processes the automation process; and
a database to set all book database from book code, book setting, page, data user, and book grouping.

2. The digital book system from claim 1, where the book code is unique and is owned only by one book, that there will be no similar book codes in the system.

3. The digital book system from claim 2, where the book code consists of a minimum 5×3 code in a form of alpha numeric and the first five digits of the code determine the cover of the book.

4. The digital book system from claim 1, where the page code is in the form of number showing the book page.

5. Digital The digital book system from claim 1, where the backend server functions to scan imagery code where the image scanning result will be sent to server by the application translated by processing the image produced and compared existing characters/codes to obtain written characters/codes.

6. The digital book system from claim 1, where the backend server also functions for page automation when during the user scans the book after the code is obtained, the backend server will order book setting automatically based on the related page.

7. The digital book system from claim 1, where the database used is MYSQ1 and SQL.

8. A method of obtaining digital book comprising:
buying offline to online book where in the book there is a book code to be inserted into the application menu;
entering the book code,
registering a username and a password before using the application on the a registration web;
enlisting in the web where a user obtains the username and the password to log into the application;
downloading the application;
Logging in the application to the server by entering the setting menu;
entering the username and the password; and
returning to a main menu by choosing ‘home’.

9. The method of obtaining digital book which consists of claim 2, furthermore comprising choosing ‘plus’ button on the main page to insert new book and entering the book code bought and its title.

10. The method of obtaining digital book which consists of claim 2, where during the book code is inserted and returning to the main menu, the cover of the book bought will be visible on the bookshelf display.
